(19) United States
(12) Patent Application Publication
(10) Pub. No.: US 2010/0231868 A1
(43) Pub. Date: Sep. 16, 2010

(54) DISPLAY DEVICE

(75) Inventors: Guo-Zen CHEN, Sindian City (TW); Ming-Hua Wen, Sindian City (TW); Chih-Hsiao Chen, Sindian City (TW)

Correspondence Address: Muncy, Geissler, Olds & Lowe, PLLC, 4000 Legato Road, Suite 310, FAIRFAX, VA, 22033, US

(73) Assignee: ALViS Technologies Inc.

(21) Appl. No.: 12/403,680

(22) Filed: Mar. 13, 2009

(51) Int. Cl. G03B 21/28

(52) U.S. Cl. 353/82

(57) ABSTRACT

A display device is revealed. The display device includes a laser source for emitting a laser beam, a pre-optics for processing the laser beam, a light scan member such as a MEMS mirror for converting the processed laser beam into a scanning light beam, and/or a corresponding post-optics. A switch-control beam splitter is disposed on the light path of the laser beam, after the light scan member so as to divide the scanning light beam into a reflected light beam and a transmitted light beam. They are two different light paths and generate a virtual image as well as a real image respectively.

### BACKGROUND OF THE INVENTION

The present invention relates to a display device, especially to a display device with a beam splitter that users can choose a real image projection mode or a virtual image projection mode.

The portable devices available now such as cell phones, personal digital assistants (PDA), handheld game consoles and notebooks are all disposed with display devices. Generally, the display devices show either real images or virtual images. Refer to FIG. 1, a virtual image display device 1 shows images in a virtual projection mode. The virtual image display device 1 includes a laser source 10 such as a red-green-blue (R, G, B) laser source for emitting tricolor laser beam 11. The laser beam 11 firstly passes a pre-optics 12 formed by collimators, cylindrical mirrors, reflectors, zoom lens sets, or their combinations for forming parallel laser beam, light path arrangement, or laser beam focus adjustment. Then by a light scanner 13 such as MEMS mirrors (micro electronic mechanic system oscillatory mirror), the laser beam 11 becomes a scanning light beam 14 to be incident into a corresponding post-optics 15 formed by line scan lenses, enlarging lens set or their combinations. Then the light beam is projected outward, into user's eye 2. Through the eye 2 optical system, an image is formed on the retina. A projected image 16 (virtual image) is generated correspondingly. Thus users see a virtual image 16 in front thereof. For example, a microdisplay device hanging in front of the eye, the virtual image 16 is formed on the positions beyond the distance of distinct vision of the eye 2 so that the user can see the virtual image 16 comfortably. Moreover, the laser beam entering the eye 2 must be reduced within the range that fits eye-safety requirement for protection of eyes 2.

As shown in U.S. Pat. No. 4,979,030, U.S. Pat. No. 5,920,361, U.S. Pat. No. 5,966,009, U.S. Pat. No. 6,140,979, U.S. Pat. No. 6,426,781 B1, U.S. Pat. No. 6,594,090 B2, U.S. Pat. No. 6,945,652 B2 and JP Pat. 11-305710 etc, display devices for producing real images (or projection display device) are revealed. Refer to FIG. 2, a display device for producing real images 3 shows images by real projection mode and consists of a laser source 30 such as a red-green-blue (R, Q B) laser source for emitting tricolor laser beam 31. The laser beam passes through a pre-optics 32 (similar to the pre-optics 12) and an optical scanner such as MEMS mirror so as to form a scanning light beam 34. The scanning light beam 34 passes a post-optics 35 (similar to the post-optics 15) to be focused and projected onto a screen and form a real image 36. Generally, the virtual image display device 1 is always disposed with the post-optics 15 while the display device for producing real images 3 is not necessary to be arranged with the post-optics 35. Moreover, while using the display device for producing real images 3, the surrounding light conditions should be taken into consideration. In order to have a certain/clear vision, a laser beam 31 with higher intensity is required.

However, the display devices of portables available now are only with a single display mode so that there are some problems raised in manufacturing or use. As shown in FIG. 1 & FIG. 2, the projection modes of the virtual image display device 1 and the display device for producing real images 3 are different so that they are used in different ways. For example, the virtual image display device 1 is often worn or hung around the eyes while the and the display device for producing real images 3 is set on the table or is held to project images onto a screen. The two post-optics 15, 35 used are also different from each other so that the design and manufacturing of the display devices are restricted and are unable to be integrated into one piece. This also causes duplicate components such as laser sources 10/30, pre-optics 12/32, optical scanners 13/33 and waste of resources. Furthermore, when users operate the portables, they may have various requirements at different time and space. For example, for personal use, the virtual projection mode is used because of the narrower viewing angle for protection of users' privacy. When the user wants to share the images with others, the real projection mode is selected. Multimedia information such as moves, photos, and slides is shared. However, the display devices on portables available now only have a single mode and users have no more choices. This leads to trouble and inconvenience in use.

### SUMMARY OF THE INVENTION

Therefore it is a primary object of the present invention to provide a display device that includes a laser source, a pre-optics, a light scan member, and/or a post-optics. A switch-control beam splitter is disposed on the light path of the laser beam, after the light scan member. Thus after traveling through the beam splitter, the scanning light beam is divided into a reflected light beam and a transmitted light beam in two different light paths for different projection modes so as to generate virtual images and real images respectively. Thereby, users operate and switch the beam splitter to different mode so as to achieve both real image projection and virtual image projection. Therefore, the efficiency and applications of the display device are improved.

It is another object of the present invention to provide a display device in which the size of the projected images is designed into two types—fixed type or adjustable type. By optical zoom of the pre-optics and/or post-optics, the magnification or minimization of the projected images is controllable.

### BRIEF DESCRIPTION OF THE DRAWINGS

FIG. 1 is a schematic drawing showing structure of a prior art of a virtual image display device;

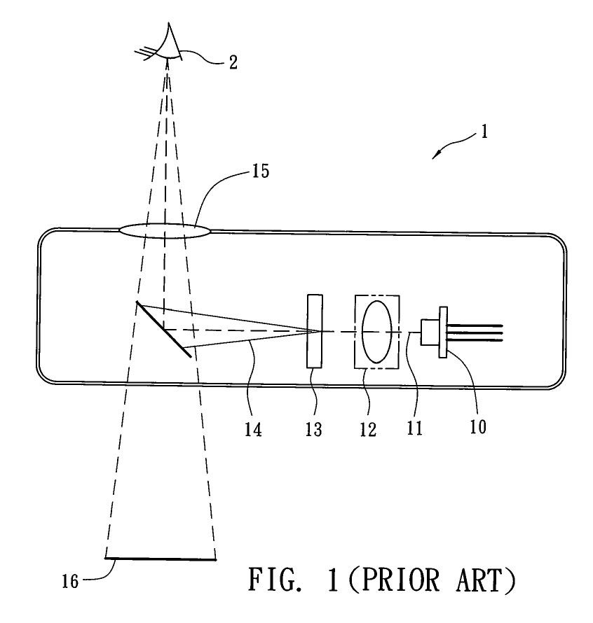

FIG. 2 is a schematic drawing showing structure of a prior art of a display device for producing real images;

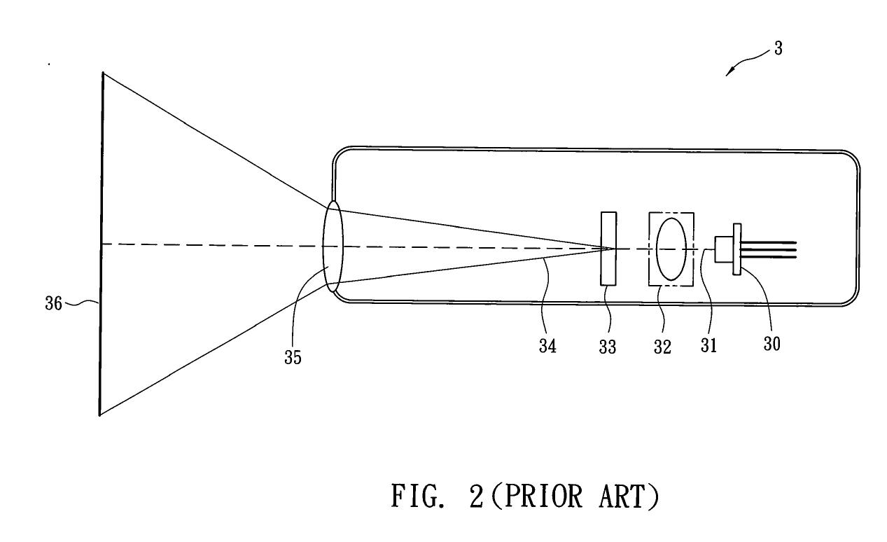

FIG. 3 is a schematic drawing showing structure of an embodiment according to the present invention;

FIG. 4 is a schematic drawing showing the embodiment in FIG. 3 switched to a virtual projection mode;

FIG. 5 is a schematic drawing showing the embodiment in FIG. 3 switched to a real projection mode;

FIG. 6 is a schematic drawing showing the embodiment in FIG. 3 being used in the virtual projection mode and the real projection mode.

### DETAILED DESCRIPTION OF THE PREFERRED EMBODIMENT

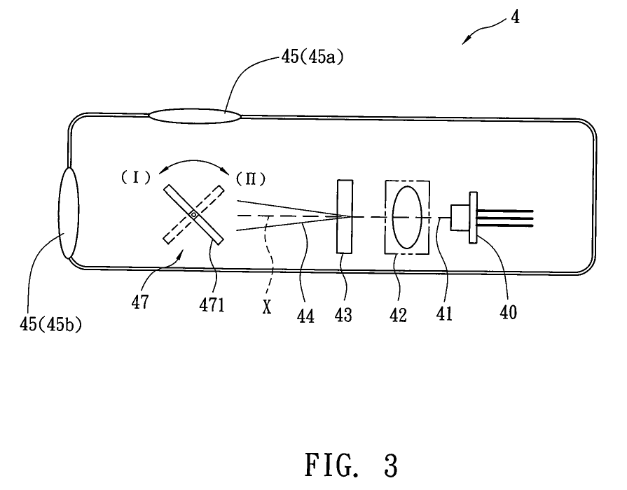

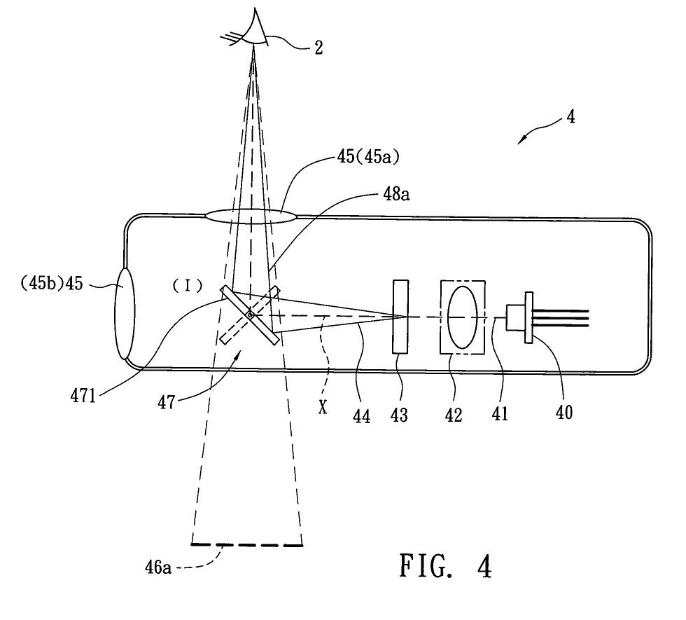

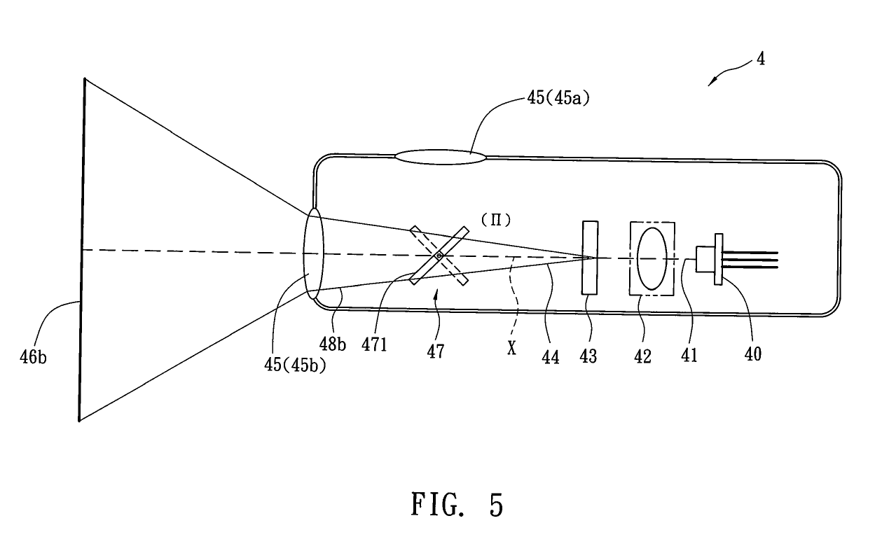

Refer to FIG. 3, FIG. 4 & FIG. 5, a display device that switches between a real projection mode and a virtual projection mode can be applied to various portable electronics such as cell phones, personal digital assistants (PDA), handheld game consoles and notebooks. Similar to those of general display devices, the display device 4 includes basic components from a light source end to a projection end sequentially: a laser source 40 such as a red-green-blue laser source for emitting a laser beam 41, a pre-optics 42 formed by collimators, cylindrical mirrors, reflectors, zoom lens sets, or their combinations so as to form a parallel laser beam, arrange light paths of the laser beam or adjust laser beam focus, a light scan member 43 such as a MEMS mirror for converting the laser beam 41 into a scanning light beam 44, and/or a corresponding post-optics 45 (45a/45b) formed by line scan lenses, enlarging lens set or their combinations. Yet in other embodiments of the present invention, the disposition of the post-optics 45 (45a/45b) is not necessary, depending on the design thereof. The scanning light beam 44 firstly passes the post-optics 45 (45a/45b) to be incident into an eye 2 or a projection plane (screen), or the scanning light beam 44 is directly incident into the eye 2 or the injection plane for showing a virtual image 46a or a real images 46b. There is no limits on structure and type of each component—the laser source 40, the pre-optics 42, the light scan member 43, and the post-optics 45 (45a/45b) and components or modules with various designs can be selected according to users' requirements.

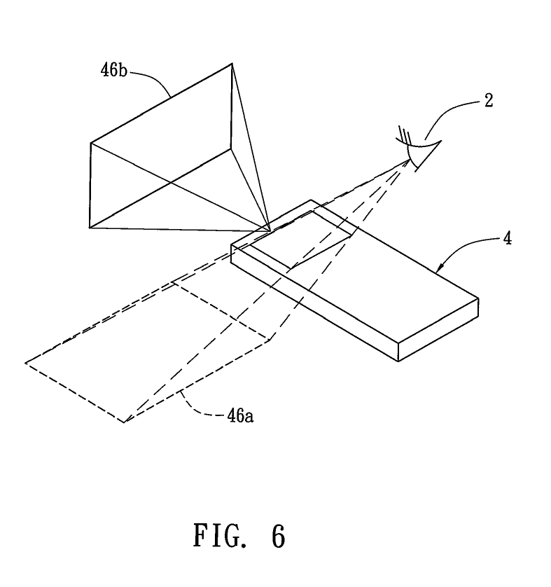

The display device 4 of the present invention features on that: a switch-control beam splitter 47 arranged between the light scan member 43 and the post-optics 45 (45a/45b). By the light dispersion function, the scanning light beam 44 is divided into two emergent light beams when the scanning fight beam 44 travels through the beam splitter 47. One is a reflected light beam 48a reflected by the beam splitter 47, as shown in FIG. 4. And the other is transmitted light beam 48b passing through the beam splitter 47, as shown in FIG. 5. The reflected light beam 48a can first travels through a post-optics 45a and then projects, or directly projects outward onto the eye 2 so that a virtual image 46a is generated by projection. That means the user can see the virtual image 46a in front of the eye 2. As to the transmitted light beam 48b, it passes a post-optics 45b in advance and then to be focused and projected onto a screen or is directly focused and projected onto the screen to form a real image 46b. Thereby, users can operate the beam splitter 47 according to their needs such as adjust the angle of the beam splitter 47 being switched. Thus the single display device 4 is switched to the virtual projection mode in FIG. 4 or the real projection mode in FIG. 5 easily and conveniently so as to achieve both real image projection and virtual image projection, as shown in FIG. 6.

In the display device 4 of the present invention, the switch-control beam splitter 47 is disposed on the light path of the scanning light beam 44 and is preferably arranged on a central optical axis of the scanning light beam 44. That means the scanning light beam 44 performs scanning symmetrical to the central optical axis so that scanning angles on two sides of the central optical axis X is equal to each other. Moreover, the switch control way of the beam splitter 47 can be designed into a switching between a first position (I) and a second position (II). When a mirror surface 471 of the beam splitter 47 is adjusted to the first position (I), an angle between the mirror surface 471 and the central optical axis X of the scanning light beam 44 is 45 degrees and the mirror surface 471 is with negative slope. The beam splitter 47 is represented by solid line in FIG. 3. Thus the scanning light beam 44 is reflected to form a reflected light beam 48a that emits into the post-optics 45a, as shown in FIG. 4. When the mirror surface 471 of the beam splitter 47 is adjusted to the second position (II), an angle between the mirror surface 471 and the central optical axis X of the scanning light beam 44 is 45 degrees and the mirror surface 471 is with positive slope, as shown in FIG. 5. The beam splitter 47 is represented by dotted line in FIG. 3. The tilt angle is not limited to 45 degrees, as long as the scanning light beam 44 is unable to be reflected to the post-optics 45a after the scanning light beam 44 entering the beam splitter 47, as shown in FIG. 5.

That means once the beam splitter 47 is switched out of the first position (I), there is no reflected light beam 48a projected onto the eye 2 so that no virtual image 46a is generated. As to the transmitted light beam 48b, no matter the beam splitter 47 is switched to the first position (I) or the second position (II), part of the scanning light beam 44 passes through the beam splitter 47 to form the transmitted light beam 48b projecting outward. Furthermore, a controllable adjusting shutter (not shown in figure) is arranged on an inner surface or an outer surface of the post-optics 45b in real projection mode. Thus in the virtual projection mode, as shown in FIG. 4, the shutter blocks the transmitted light beam 48b so that it is unable to be projected outward to form the real image. Thereby, users can operate the beam splitter 47 switching between the first position (I) and the second position (II) so as to make the display device 4 of the present invention provides both real image projection and virtual image projection.

In addition, the function of the beam splitter 47 that divides the scanning light beam 44 into the reflected light beam 48a and the transmitted light beam 48b is a conventional technique and the ratio of the transmitted light beam 48b to the reflected light beam 48a can be set to 90%:10% or other values according to actual demands. In this embodiment, the ratio of the reflected light beam 48a is much lower than that of the transmitted light beam 48b for protection of the eye 2. In order to prevent the harm of the eye, the laser beam entering the eye 2 (reflected light beam 48a) is reduced within the range that fits eye-safety requirement while the transmitted light beam 48b is focused and projected onto a screen to form a real image 46a so that the transmitted light beam 48b with higher intensity is required for a certain/clear vision considering surrounding light conditions.

The size of the display device 4 of the present invention—that means the size of the projected images 46a, 46b can be designed into two types—fixed type or adjustable type. By optical zoom of the pre-optics 42 and/or post-optics 45, the magnification or minimization of the projected images 46a, 46b is controllable. Once the pre-optics 42 and/or post-optics 45 is designed to the fixed type, the projected images 46a, 46b are with certain size and are unable be adjusted. Or the pre-optics 42 and/or post-optics 45 is designed to the adjustable type, the size of the projected images 46a, 46b can be adjusted within a certain range by the external users.

Various portable devices can be built in with the display device 4 of the present invention so that users can use the display device whenever they need. Or the display device 4 is designed into a single device, as shown in FIG. 3, and is connected with portable devices by compatible connectors (not shown in figure).

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A display device comprising a laser source for emitting a laser beam, a pre-optics for forming parallel laser beam, light path arrangement, or laser beam focus adjustment, a light scan member for converting the processed laser beam into a scanning light beam, and/or a corresponding post-optics that is passed by the scanning light; wherein a switch-control beam splitter is disposed on a light path of the laser beam, after the light scan member so that while the scanning light beam passing the beam splitter, part of the scanning light beam is reflected by the beam splitter to form a reflected light beam while part of the scanning light beam travels through the beam splitter to form a transmitted light beam and the two light beams are two separated emergent light beams in two different light paths respectively for virtual projection mode and real projection mode so as to generate a virtual image and a real image; the switch-control beam splitter is switched along with various requirements so that the display device projects both real images and virtual images.

2. The device as claimed in claim 1, wherein the pre-optics is formed by collimators, cylindrical mirrors, reflectors, zoom lens sets, or combinations of them.

3. The device as claimed in claim 1, wherein the light scan member is a MEMS mirror.

4. The device as claimed in claim 1, wherein the post-optics includes a post-optics for virtual projection mode and a post-optics for real projection mode.

5. The device as claimed in claim 1, wherein the beam splitter is disposed on a light path of the scanning light beam, after the light scan member and is on a central optical axis of the scanning light beam symmetrically.

6. The device as claimed in claim 1, wherein

7. The device as claimed in claim 1, wherein ratio of the transmitted light beam to the reflected light beam is set to 90%:10%.

8. The device as claimed in claim 1, wherein the transmitted light beam is projected to generate a real image while the reflected light beam is projected to generate a virtual image.

9. The device as claimed in claim 1, wherein size of the image of the virtual projection mode or the real projection mode of the display device is fixed.

10. The device as claimed in claim 1, wherein size of the image of the virtual projection mode or the real projection mode of the display device is adjustable.

11. The device as claimed in claim 10, wherein the adjustable size of the image is achieved by optical zoom of the pre-optics and/or post-optics.
